(19) United States
(12) Patent Application Publication
(10) Pub. No.: US 2026/0307660 A1
(43) Pub. Date: Oct. 8, 2026

(54) VEHICLE BEACH MODE

(71) Applicant: Ford Global Technologies, LLC, Dearborn, MI (US)

(72) Inventors: Keith Weston, Canton, MI (US); Zackary Swisher, Taylor, MI (US); Andrew Brady Brown, Royal Oak, MI (US)

(73) Assignee: Ford Global Technologies, LLC, Dearborn, MI (US)

(21) Appl. No.: 19/169,619

(22) Filed: Apr. 3, 2025

(51) Int. Cl. B60W 50/00; B60W 30/14; B60W 50/14

(52) U.S. Cl. CPC B60W 50/0097; B60W 30/146; B60W 50/14; B60W 2540/215; B60W 2554/80; B60W 2555/20; B60W 2556/45

(57) ABSTRACT

A vehicle including a processor and a memory is disclosed. The processor may identify that the vehicle is entering a beach environment, and activate a beach mode responsive to identifying that the vehicle is entering the beach environment. The processor may predict a shoreline on the beach at a given time when the beach mode is activated, and determine a probability of the vehicle interacting with water at a given location on the beach based on the shoreline. Based on the probability, the processor may cause the vehicle to perform a predefined action.

### FIELD

The present disclosure relates to vehicles and more specifically to a beach mode feature for a vehicle.

### BACKGROUND

People enjoy driving on beaches, where the sandy shores are wide and accessible to vehicles. People often tow their camper trailers onto the beach, creating a setup for a relaxing and immersive coastal camping experience. Many people park their vehicles on the beach, recreation, and relaxation areas for easy access to swimming, picnics, and water activities.

Sometimes, when the vehicles are parked on the beach, the tide can rise, causing the water to flow closer to the location on which the vehicles are parked. The water may cause a vehicle to get stuck in the soft, wet sand.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of a system to optimize vehicle operation on a beach, in accordance with the present disclosure.

FIG. 3 depicts an example notification on a user interface, in accordance with the present disclosure.

FIG. 4 depicts an example view of a vehicle in proximity to a signage on a beach, in accordance with the present disclosure.

FIG. 5 depicts a flow diagram of an example method to optimize vehicle operation on a beach, in accordance with the present disclosure.

### DETAILED DESCRIPTION

### Overview

The present disclosure describes a system and method that may enable a vehicle to efficiently operate on a beach, without causing any inconvenience to the vehicle user/operator. For instance, the system may assist the vehicle in driving and parking on the beach. In some aspects, the system may cause the vehicle to operate on the beach such that the vehicle may not interact with the water on the beach. The system may leverage vehicle sensors and/or information obtained from an external server to enable the vehicle to efficiently operate on the beach, as briefly described below.

The system may first determine/identify that the vehicle is entering (or has entered) a beach environment. In some aspects, the system may obtain inputs from the vehicle sensors (e.g., vehicle cameras) and detect the presence of sand, water, paved surfaces, etc. based on the inputs, to determine that the vehicle is entering (or has entered) the beach environment. In other aspects, the system may obtain inputs from the server (e.g., map information) and determine that the vehicle is entering (or has entered) the beach environment based on the server inputs. In further aspects, the system may obtain inputs from the vehicle user, from other vehicles (e.g., via vehicle-to-vehicle-communication), from infrastructure units (e.g., via vehicle-to-everything (V2X) communication) and/or the like, to determine that the vehicle is entering (or has entered) the beach environment.

Responsive to determining that the vehicle is entering the beach environment, the system may determine waves and tides pattern. The waves and tides pattern may indicate how far the water may reach on the beach at a given time. To determine the waves and tides pattern associated with the beach, the system may perform the following actions. In some aspects, the system may estimate or predict a tide location at a given time on the beach (or how the tides may change with time) based on the inputs described above (e.g., the inputs obtained from the vehicle sensors and/or the server). The tide location refers to a position of water along a shoreline and indicates how far the water may reach on the beach at a given time. In further aspects, the system may obtain weather information associated with the beach from the server. The weather information may include the wind speed and wind direction, which may affect the waves on the beach. The system may further observe/detect strandline on the beach using the vehicle sensors.

Based on the determination of the waves and tides pattern, the system may predict a location of the shoreline on the beach at the given time. Based on the prediction of the shoreline location, the system may optimize the vehicle operation on the beach such that the vehicle may not interact with water on the beach. Specifically, the system may determine a probability of the vehicle interacting with water at a given location on the beach based on the shoreline location and preform a predefined action based on the probability to prevent the vehicle from interacting with the water. For example, when the probability of the vehicle interacting with water is greater than a threshold value (e.g., when the vehicle may be parked on the beach and the distance between the shoreline and the vehicle is less than 50 meters or 30 meters), the system may perform a remedial action to protect the vehicle from the water. For instance, the system may automatically relocate the vehicle from a current vehicle location to another location on the beach. Alternatively, the system may output a notification for a user, via a user interface (e.g., a user interface associated with a user device or a vehicle Human-Machine Interface (HMI)), requesting the user to move the vehicle from the current vehicle location to another location on the beach. In some aspects, the system may identify an optimal parking location on the beach based on the location of the shoreline mentioned above, such that the vehicle may not interact with water when the vehicle is parked at the optimal parking location.

In addition, the vehicle sensor (e.g., the vehicle camera) may capture images of a signage located at the beach. The system may obtain these inputs associated with the signage from the vehicle sensor, determine a geofenced boundary for the vehicle on the beach based on the inputs, and cause the vehicle to operate within the geofenced boundary. The signage may indicate the designated areas for walkers and vehicles on the beach, speed limit, recommendation of four-wheel drive (4WD), especially if the sand is loose or deep, and/or the like.

The present disclosure discloses a system that assists a user to operate the vehicle on the beach, without any inconvenience. The system prevents the vehicle from being stuck in the soft and wet sand, by using existing vehicle components. In addition, the system assists the vehicle to operate as per the guidelines associated with the beach and/or a fleet manager.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

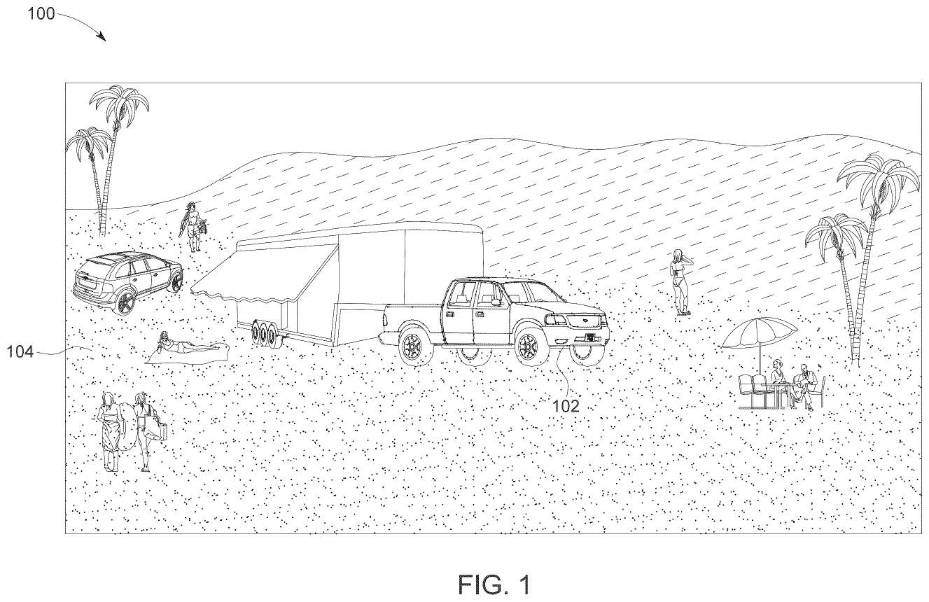

FIG. 1 depicts an example environment 100 in which techniques and structures for providing the systems and methods disclosed herein may be implemented. The environment 100 may include a vehicle 102 that may be operating on a beach 104 (or in a beach environment).

The vehicle 102 may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode. Further, the vehicle 102 may include any powertrain, such as a gasoline engine, one or more electrically-actuated motor(s), or a hybrid system.

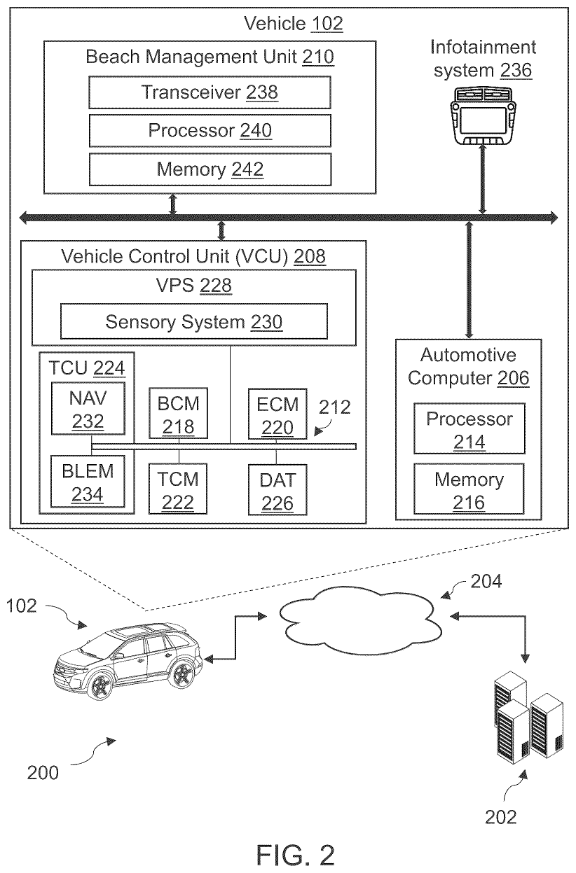

The vehicle 102 may include a beach management unit (shown as beach management unit 210 in FIG. 2) that may manage vehicle operations when the vehicle 102 may be located on the beach 104. The beach management unit (or “unit”) may optimize the vehicle operation when the vehicle 102 operates on the beach 104. The unit may facilitate a vehicle operator (or a user) to operate the vehicle 102 on the beach 104 (e.g., drive on the beach 104 and park the vehicle 102 at an optimal parking location), such that the vehicle 102 may not interact with the water on the beach 104. In addition, the unit may facilitate the user to operate the vehicle 102 within a geofenced boundary designated for vehicles on the beach 104. An example operation of the unit is briefly described below and described in detail later in conjunction with FIG. 2.

In some aspects, the unit may obtain inputs from a vehicle sensor and/or an external server (shown as server 202 in FIG. 2) and optimize the vehicle operation on the beach 104 based on the obtained inputs. In some aspects, the unit may activate a beach mode when the vehicle 102 is located on the beach 104. Responsive to activating the beach mode, the unit may estimate or predict a tide location at a given time on the beach 104 (or how the tides may change with time) based on the obtained inputs described herein. The tide location refers to a position of water along a shoreline and indicates how far the water may reach on the beach 104 at the given time. It may be appreciated that the shoreline may shift (or fluctuate) based on the tides (and wave action). The unit may estimate or predict a location of a shoreline on the beach 104 at a given time, based on the prediction of the tide location. The shoreline refers to a boundary where the water meets the land.

Based on the prediction of the shoreline location, the unit may optimize vehicle operation on the beach 104 such that the vehicle 102 may not interact with water on the beach 104. Specifically, the unit may determine a probability of the vehicle 102 interacting with water at a given location on the beach 104 based on the shoreline location and preform a predefined action based on the probability to prevent the vehicle 102 from interacting with the water. For example, when the probability of the vehicle 102 interacting with water is greater than a threshold value (e.g., when the vehicle 102 may be parked on the beach 104 and the distance between the shoreline and the vehicle 102 is less than 50 meters or 30 meters), the unit may perform a remedial action to protect the vehicle 102 from water. For instance, the unit may automatically relocate the vehicle 102 from a current vehicle location to another location on the beach 104. Alternatively, the unit may output a notification to a user, via a user interface (e.g., associated with a user device or a vehicle Human-Machine Interface (HMI)), requesting the user to move the vehicle 102 from the current vehicle location to another location on the beach 104.

In further aspects, the unit may identify the optimal parking location for the vehicle 102 on the beach 104 based on the shoreline location, such that the vehicle 102 may not interact with water when the vehicle 102 is parked at the optimal parking location. For instance, the unit may estimate a high tide water position and a low tide water position based on the inputs described above and may recommend the vehicle 102 to park above the high tide water position on the beach 104 (as the optimal parking location).

In addition, the vehicle sensor (e.g., a vehicle camera) may capture images of a signage located in the beach environment. The unit may obtain inputs associated with the signage from the vehicle sensor, determine geofenced boundaries for the vehicle 102 on the beach 104 based on the obtained inputs, and cause the vehicle to operate within the geofenced boundaries. The signage may indicate designated areas for walkers and vehicles on the beach 104, speed limit, recommendation of four-wheel drive (4WD), especially if the sand is loose or deep, and/or the like.

Further vehicle 102 details are described below in conjunction with FIG. 2.

The vehicle 102 implements and/or performs operations, as described here in the present disclosure, in accordance with the owner manual and safety guidelines. In addition, any action taken by the user based on the notifications provided by the vehicle 102 should comply with all the rules specific to the location and operation of the vehicle 102 (e.g., Federal, state, country, city, etc.). The notifications, as provided by the vehicle 102, should be treated as suggestions and only followed according to any rules specific to the location and operation of the vehicle 102.

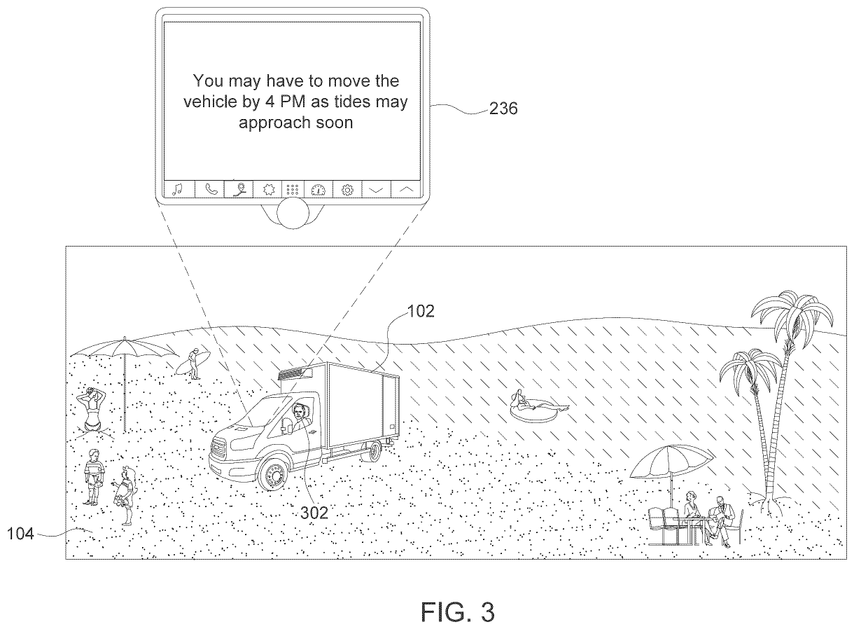

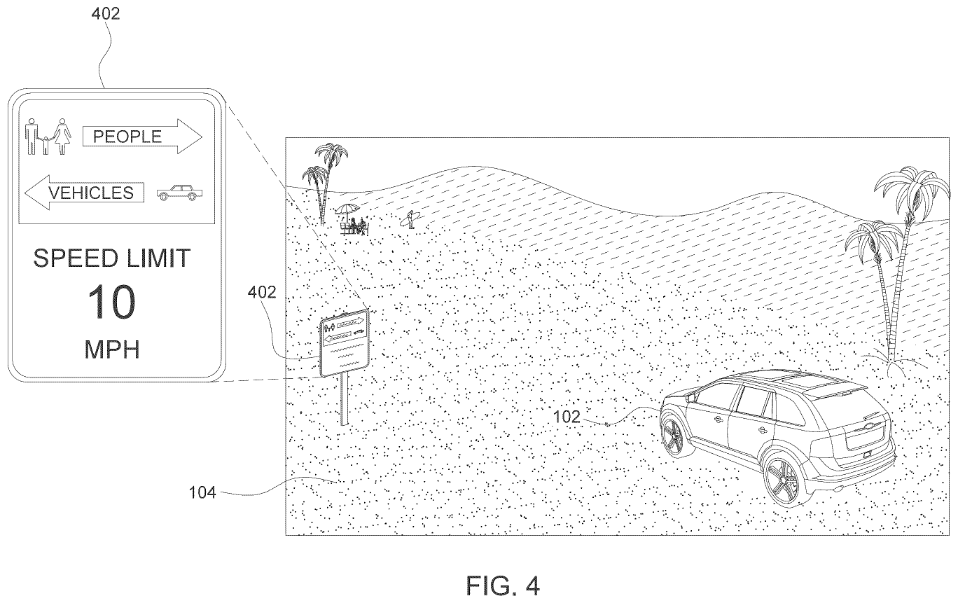

FIG. 2 depicts a block diagram of a system 200 to optimize vehicle operation on the beach 104, in accordance with the present disclosure. While describing FIG. 2, references will be made to FIGS. 3 and 4.

The system 200 may include the vehicle 102 and one or more servers 202 (or a server 202) that may be communicatively coupled with each other via one or more networks 204. The server 202 may be part of a cloud-based computing infrastructure and may be associated with and/or include a Telematics Service Delivery Network (SDN) that provides digital data services to the vehicle 102 and other vehicles (not shown in FIG. 2) that may be part of a vehicle fleet. In further aspects, the server 202 may store tide information associated with the beach 104. The tide information may include tide position information associated with the beach 104, tide schedule associated with the beach 104 (e.g., high tide and low tide schedule), and/or the like. In further aspects, the server 202 may store weather information associated with the beach 104. The weather information may include information associated with wind speed and direction (which may affect the wave pattern on the beach 104). The server 202 may transmit this information to the vehicle 102 at a predefined frequency or when the vehicle 102 transmits a request to the server 202 to obtain such information. In some aspects, the vehicle 102 may obtain such information from the server 202 when the vehicle 102 enters the beach environment.

The network(s) 204 illustrates an example communication infrastructure in which the connected devices discussed in various embodiments of this disclosure may communicate. The network(s) 204 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 102 may include a plurality of units including, but not limited to, an automotive computer 206, a Vehicle Control Unit (VCU) 208 and a beach management unit 210 (or unit 210). The VCU 208 may include a plurality of Electronic Control Units (ECUs) 212 in communication with the automotive computer 206.

In some aspects, the automotive computer 206 and/or the unit 210 may be installed anywhere in the vehicle 102, in accordance with the disclosure. Further, the automotive computer 206 may operate as a functional part of the unit 210. The automotive computer 206 may be or include an electronic vehicle controller, having one or more processor(s) 214 and a memory 216. Moreover, the unit 210 may be separate from the automotive computer 206 (as shown in FIG. 2) or may be integrated as part of the automotive computer 206.

The processor(s) 214 may be in communication with one or more memory devices in communication with the respective computing systems (e.g., the memory 216 and/or one or more external databases not shown in FIG. 2). The processor(s) 214 may utilize the memory 216 to store programs in code and/or to store data for performing aspects in accordance with the disclosure. The memory 216 may be a non-transitory computer-readable medium or memory storing a beach management program code. The memory 216 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 208 may share a power bus with the automotive computer 206 and may be configured and/or programmed to coordinate the data between vehicle 102 systems, connected servers (e.g., the server(s) 202), and other vehicles (not shown in FIG. 2) operating as part of a vehicle fleet. The VCU 208 may include or communicate with any combination of the ECUs 212, such as a Body Control Module (BCM) 218, an Engine Control Module (ECM) 220, a Transmission Control Module (TCM) 222, a Telematics Control Unit (TCU) 224, a Driver Assistances Technologies (DAT) controller 226, etc.

The VCU 208 may further include and/or communicate with a Vehicle Perception System (VPS) 228, having connectivity with and/or control of one or more vehicle sensory system(s) 230 (or a “sensor unit”). The vehicle sensory system 230 may include one or more vehicle sensors including, but not limited to, a radio detection and ranging (radar) sensor configured for detection and localization of objects inside and outside the vehicle 102 using radio waves, sitting area buckle sensors, sitting area sensors, a light detecting and ranging (lidar) sensor, door sensors, proximity sensors, temperature sensors, wheel sensors, ambient weather sensors, ambient light sensors, vehicle interior and exterior cameras, one or more rain sensors, a humidity sensor, a tire pressure sensor, ultrasonic sensors, etc. In some aspects, the vehicle sensory system 230 (e.g., vehicle exterior camera) may capture images of a vehicle surrounding area.

In some aspects, the VCU 208 may control vehicle operational aspects and implement one or more instruction sets received from a user device (not shown) associated with a vehicle user, from one or more instruction sets stored in the memory 216, including instructions operational as part of the unit 210. The user device may be, for example, a tablet, a laptop, a smart watch, or any other device with communication capabilities.

The TCU 224 may provide vehicle connectivity to wireless computing systems onboard and off board the vehicle 102 and may include a Navigation (NAV) receiver 232 for receiving and processing a GPS signal, a BLE Module (BLEM) 234, a Wi-Fi transceiver, a UWB transceiver, and/or other wireless transceivers (not shown in FIG. 2) that may be configurable for wireless communication (including cellular communication) between the vehicle 102 and other systems (e.g., the user device, a key fob, an NFC device, etc.), computers, and modules. The NAV receiver 232 may be configured to determine a real-time vehicle geolocation. The TCU 224 may be in communication with the ECUs 212 by way of a bus.

The ECUs 212 may control aspects of vehicle operation and communication using inputs from human drivers, inputs from an autonomous vehicle controller, the unit 210, and/or via wireless signal inputs received via the wireless connection(s) from other connected devices, such as the user device associated with the vehicle user, the server(s) 202, among others.

The BCM 218 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, enclosures, and/or the like. The BCM 218 may also operate as a gateway for bus and network interfaces to interact with remote ECUs (not shown in FIG. 2).

The DAT controller 226 may provide Level-1 through Level-3 automated driving and driver assistance functionality that may include, for example, active parking assistance, vehicle backup assistance, and adaptive cruise control, among other features. The DAT controller 226 may also provide aspects of user and environmental inputs usable for user authentication.

In some aspects, the automotive computer 206 may connect with an infotainment system 236 (or a vehicle Human-Machine Interface (HMI) 236). The infotainment system 236 may include a touchscreen interface portion and may include voice recognition features, biometric identification capabilities that can identify users based on facial recognition, voice recognition, fingerprint identification, or other biological identification means. In other aspects, the infotainment system 236 may further receive user instructions/inputs via the touchscreen interface portion and/or display notifications/recommendations, navigation maps, etc. on the touchscreen interface portion.

The computing system architecture of the automotive computer 206, the VCU 208, and/or the unit 210 may omit certain computing modules. It should be readily understood that the computing environment depicted in FIG. 2 is an example of a possible implementation according to the present disclosure, and thus, it should not be considered limiting or exclusive.

In accordance with some aspects, the unit 210 may be integrated with and/or executed as part of the ECUs 212. The unit 210, regardless of whether it is integrated with the automotive computer 206 or the ECUs 212, or whether it operates as an independent computing system in the vehicle 102, may include a transceiver 238, a processor 240, and a computer-readable memory 242.

The transceiver 238 may receive information/inputs from one or more external devices or systems, e.g., the user device associated with the user, the server(s) 202, and/or the like via the network 204. For example, the transceiver 238 may receive the information associated with tides and weather from the server 202 via the network 204. Further, the transceiver 238 may transmit notifications/data/signals to the external devices or systems. In addition, the transceiver 238 may receive information/inputs from vehicle 102 components such as the infotainment system 236, the vehicle sensory system 230, the VCU 208, and/or the like. Further, the transceiver 238 may transmit notifications/command signals to the vehicle 102 components such as the VCU 208, the infotainment system 236, the BCM 218, etc.

The processor 240 and the memory 242 may be the same as or similar to the processor 214 and the memory 216, respectively. In some aspects, the processor 240 may utilize the memory 242 to store programs in code and/or to store data for performing aspects in accordance with the disclosure. The memory 242 may be a non-transitory computer-readable medium or memory storing the beach management program code.

In operation, the processor 240 may first identify that the vehicle 102 is entering the beach environment (or the beach 104). In some aspects, the processor 240 may obtain a first input from a sensor (e.g., a vehicle camera, which may be part of the vehicle sensory system 230) and identify that the vehicle 102 is entering the beach environment based on the first input. For instance, the processor 240 may detect the presence of beach entry, sand, water, beach signs, etc. based on the inputs obtained from the sensor and identify that the vehicle 102 is entering the beach 104 responsive to detecting the presence of such items. In further aspects, the processor 240 may obtain a second input from the server 202, which may be associated with the geolocation of the beach 104. The processor 240 may identify that the vehicle 102 is entering the beach 104 based on the second input.

In further aspects, the processor 240 may obtain a third input from the user indicating that the vehicle 102 is entering the beach environment. In some aspects, the processor 240 may obtain the third input via a user interface. The user interface may be associated with the user device or the HMI 236. In further aspects, the processor 240 may obtain the third input, via a voice command, a user gesture, and/or the like. The processor 240 may identify that the vehicle 102 is entering the beach environment based on the third input.

In further aspects, the processor 240 may obtain a fourth input from a second vehicle (not shown) via vehicle-to-vehicle (V2V) communication and may identify that the vehicle 102 is entering the beach environment based on the fourth input. For example, when multiple vehicles are traveling together, they may share information/data with each other via V2V communication, which may enable the processor 240 to identify that the vehicle 102 is entering the beach environment. In further aspects, the processor 240 may obtain a fifth input from an infrastructure unit (e.g., a security camera mounted on the beach 104) via vehicle-to-everything (V2X) communication and identify that the vehicle 102 is entering the beach environment based on the fifth input.

Responsive to identifying that the vehicle 102 is entering the beach environment by any of the means described above, the processor 240 may activate a beach mode for the vehicle 102. In some aspects, the beach mode may remain active till the vehicle 102 is operating (moving or parked) or located on the beach 104. The processor 240 may deactivate the beach mode when the processor 240 identifies that the vehicle 102 may be exiting the beach environment. The processor 240 may identify that the vehicle 102 may be exiting the beach environment in the same manner as the processor 240 identifies that the vehicle 102 may be entering the beach environment. In further aspects, the processor 240 may deactivate the beach mode based on user inputs, via the HMI 236, voice/gesture command, and/or the like.

In some aspects, responsive to activating the beach mode, the processor 240 may determine waves and tides pattern associated with the beach 104, and cause the vehicle 102 to operate on the beach 104 such that the vehicle 102 may not interact with the water on the beach 104 based on the waves and tides pattern. The waves and tide patterns may indicate how far the water may reach on the beach 104 at a given time. It may be appreciated that shoreline may shift (or fluctuate) based on the tides (and the wave action). The processor 240 may estimate or predict the location of the shoreline on the beach 104 at a given time, based on the waves and tides pattern. To determine the waves and tides pattern associated with the beach 104, the processor 240 may perform the actions described below.

In some aspects, the processor 240 may predict a tide location on the beach 104 at the given time when the beach mode is activated. The tide location refers to a position of water along a shoreline. The processor 240 may estimate or predict the location of the shoreline on the beach 104 based on the prediction of the tide location.

In some aspects, to predict the tide location, the processor 240 may obtain a sixth input from the server 202. The sixth input may include tide information associated with the beach 104. Based on the sixth input, the processor 240 may predict the tide location. The tide information may include, for example, a tide schedule, tide position at a given time, etc. The tide schedule is a timetable that shows the predicted times and heights of high and low tides for a specific location (e.g., a location on the beach 104). The tide schedule indicates when the water level will rise (high tide) or fall (low tide) due to the gravitational pull of moon and sun. The tide schedule includes the high tide times and height (when the water reaches the highest point/level), the low tide times and height (when the water reaches the lowest point/level), the tide cycle duration (times between the high and low tides), and/or the like. For instance, the tide schedule may indicate that the low tide is scheduled at 3:27 AM and the high tide is scheduled at 9:31 AM for the beach 104.

The processor 240 may obtain such tide information from the server 202 and predict the tide location at the given time based on the obtained tide information. For example, responsive to obtaining the tide schedule, the processor 240 may estimate a high tide water position (the highest water position during a high tide) and a low tide water position (the lowest water position during a low tide) associated with the beach 104 based on the tide schedule. The processor 240 may then predict the tide location on the beach 104 based on the high tide water position and the low tide water position.

In further aspects, to predict the tide location, the processor 240 may obtain a seventh input from the sensor (e.g., the vehicle camera). For instance, the processor 240 may observe a strandline on the beach 104, via the inputs obtained from the sensor. A strandline is the line of debris, seaweed, shells, and other materials left on the beach 104 by the high tide. It marks the highest point that the tide reached before the water recedes. The processor 240 may predict the tide location on the beach 104 based on the seventh input.

In further aspects, the processor 240 may obtain an eighth input from the server 202. The eighth input may include weather information associated with the beach 104. The weather information may include the wind speed and wind direction, which may affect the waves on the beach 104. For instance, when there are strong winds, bigger waves may be generated. Onshore winds (blowing from the ocean towards the land) make the waves jerkier. On the other hand, offshore winds (blowing from the land towards the ocean) make smooth waves. The processor 240 may predict the location of the shoreline on the beach 104 based on the eighth input.

In further aspects, the processor 240 may obtain a ninth input from the sensor (e.g., the vehicle camera). For instance, the processor 240 may observe a wave height on the beach 104, via the sensor. Wave height is the vertical distance between the crest (highest point) and the trough (lowest point) of a wave. Larger waves carry more energy and can push water farther up the shore. The processor 240 may predict the location of the shoreline on the beach 104 based on the ninth input.

Responsive to predicting the location of the shoreline on the beach 104, the processor 240 may determine a probability of the vehicle 102 interacting with water at a given location on the beach 104 based on the location of the shoreline. Specifically, the processor 240 may estimate a distance between the predicted shoreline and the vehicle 102 at the given location (e.g., at any given time). The processor 240 may determine the probability of the vehicle 102 interacting with water based on the distance and cause the vehicle 102 to perform a predefined action based on the probability so that the vehicle 102 may not interact with water on the beach 104. The processor 240 may cause the vehicle 102 to operate on the beach 104 such that water may not interact with the vehicle 102 (e.g., when the vehicle 102 may be moving or parked on the beach 104).

In an exemplary aspect, responsive to determining the probability, the processor 240 may compare the probability with a threshold value (e.g., a first threshold value). Based on the comparison, when the processor 240 determines that the probability of the vehicle 102 interacting with water is greater than the first threshold value, the processor 240 may perform a remedial action so that the water may not interact with the vehicle 102. For instance, responsive to determining that the distance between the shoreline and the vehicle 102 at the given location (e.g., at any given time) is less than a second threshold value, the processor 240 may determine that the probability of the vehicle 102 interacting with water is greater than the first threshold value. Responsive to such determination, the processor 240 may perform one or more remedial actions, as described below.

In some aspects, to perform the remedial action, the processor 240 may cause the vehicle 102 to automatically relocate from a current location to another location on the beach 104, via the DAT controller 226. For instance, when the vehicle 102 is positioned/parked at the current location on the beach 104 and the probability of the vehicle 102 interacting with water at the current location is greater than the threshold value (as tides increase), the processor 240 may cause the vehicle 102 to automatically relocate from the current location to another location (away from the shoreline) on the beach 104.

In further aspects, to perform the remedial action, the processor 240 may output a first notification for a user (e.g., a user 302, shown in FIG. 3) requesting the user 302 to move the vehicle 102 from the current location to the other location on the beach 104. In some aspects, the processor 240 may activate an audible alarm associated with the vehicle 102 to indicate to the user 302 that water may interact with the vehicle 102 on the beach 104. The user may hear the alarm and may move the vehicle 102 from the current position to the other location.

In further aspects, to perform the remedial action, the processor 240 may output the first notification to the user 302 via a user interface, requesting the user 302 to move the vehicle 102 from the current location to the other location on the beach 104. The user interface may be associated with the user device and/or the HMI 236. For example, the user 302 may be sitting inside the vehicle 102 (positioned/parked at the current location on the beach 104). The processor 240 may determine the probability of the vehicle 102 interacting with water at the current location at the given time based on the inputs obtained from the sensor and/or the server 202 (as described above). In addition, the processor 240 may estimate a time until which the vehicle 102 can be positioned at the current location without interacting with water based on the inputs obtained from the sensor and/or the server 202. Based on such estimation, the processor 240 may output the first notification, e.g., “You may have to move the vehicle by 4 PM as the tides may approach soon,” as shown in FIG. 3. In further aspects, the processor 240 may activate a timer based on the estimated time and may output another notification (e.g., a second notification) when the time elapses. For instance, the processor 240 may set a timer for 3:50 PM and may output the notification/alarm when it is 3:50 PM.

In further aspects, the processor 240 may identify an optimal parking location on the beach 104 based on the shoreline location, such that the vehicle 102 may not interact with water when the vehicle 102 may be parked at the optimal parking location. For instance, based on the inputs described above, the processor 240 may estimate the high tide water position and the low tide water position and may recommend the vehicle 102 to park above the high tide water position on the beach 104 (as the optimal parking location).

In addition to preventing the vehicle 102 from interacting with water, the processor 240 may facilitate vehicle movement according to the guidelines associated with the beach 104. In this case, the vehicle 102 may obtain inputs associated with the guidelines from the sensor and/or the server 202 and may operate the vehicle 102 based on the obtained inputs. For instance, when the vehicle 102 is moving on the beach 104, the sensor (e.g., the vehicle camera) may capture images of a signage 402 (shown in FIG. 4) located on the beach 104. The signage 402 may indicate designated areas for walkers and vehicles on the beach, speed limit, recommendation of four-wheel drive (4WD), especially if the sand is loose or deep, and/or the like.

The processor 240 may obtain the inputs associated with the signage 402 from the sensor and determine geofenced boundary for the vehicle 102 on the beach 104 based on the obtained inputs. Thereafter, the processor 240 may cause the vehicle 102 to operate within the geofenced boundary. For instance, the processor 240 may determine the designated areas for the vehicles based on the content associated with the signage 402 and may output a notification to the user to stay within the designated areas. The user may view/hear the notification and may drive the vehicle 102 based on the notification. Such notifications help users build knowledge of the space that they are operating in and the guidelines associated with that space.

In further aspects, the processor 240 may obtain information associated with the speed limit to drive on the beach 104, based on the inputs obtained from the sensor (e.g., the image associated with the signage 402). Responsive to obtaining the information associated with the speed limit, the processor 240 may output another notification to the user indicating the speed limit. Alternatively, the processor 240 may set a maximum speed limit (e.g., 10 MPH) based on the obtained information and cause the vehicle 102 to move within the maximum speed limit. In some scenarios, when the user desires to move the vehicle 102 at a desired speed (that may be greater than the set maximum speed limit) in urgent situations, the user may override the maximum speed limit. In this case, the processor 240 may obtain a user request (via the transceiver 238) to enable the user to move the vehicle 102 at the desired speed greater than the maximum speed limit, and the processor 240 may then enable the vehicle 102 to move at the desired speed responsive to obtaining the user request.

The processor 240 may further generate a virtual roadway based on the inputs described above. The virtual roadway refers to a simulated or digitally created representation of a road or road network. For instance, the processor 240 may generate the virtual roadway based on the water patterns, wave, and tide information (described above). The processor 240 may communicate the virtual roadway to the user via Augmented Reality (e.g., by overlaying on camera data, voice/other ADAS related communications mechanisms).

In further aspects, the processor 240 may obtain guidelines from a fleet manager, via a fleet manager device, and may operate the vehicle 102 based on the guidelines. In further aspects, the processor 240 may enable cruise control of the vehicle 102 to enable the vehicle 102 to operate automatically on the beach 104 within the maximum speed limit.

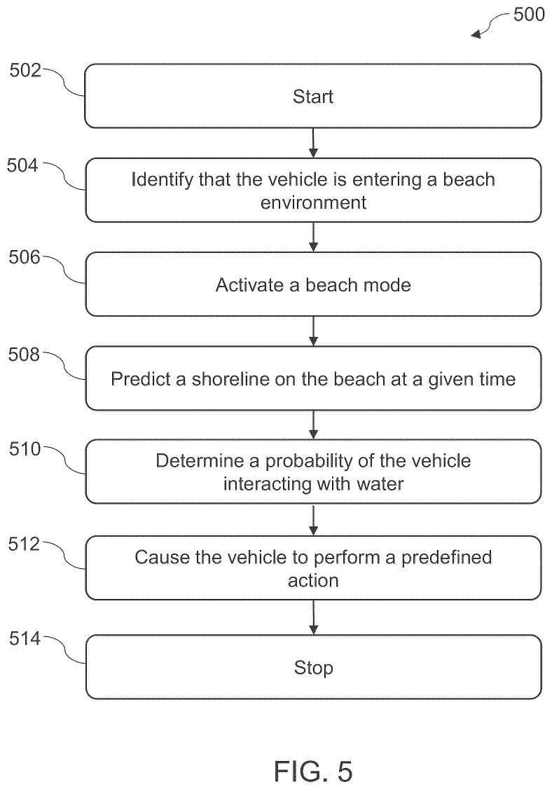

FIG. 5 depicts a flow diagram of an example method 500 to optimize vehicle operation on the beach 104, in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include identifying, by the processor 240, that the vehicle 102 is entering the beach environment (or the beach 104). At step 506, the method 500 may include activating, by the processor 240, the vehicle's beach mode responsive to identifying that the vehicle 102 is entering the beach environment. At step 508, the method 500 may include predicting, by the processor 240, a shoreline on the beach 104 at a given time, when the beach mode is activated.

At step 510, the method 500 may include determining, by the processor 240, the probability of the vehicle 102 interacting with water at a given location on the beach based on the shoreline. At step 512, the method 500 may include causing, by the processor 240, the vehicle 102 to perform a predefined action based on the probability.

At step 514, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a processor; and
a memory for storing instructions, the processor executing the instructions to:
identify that the vehicle is entering a beach environment;
activate a beach mode responsive to identifying that the vehicle is entering the beach environment;
predict a location of a shoreline on a beach at a given time, when the beach mode is activated;
determine a probability of the vehicle interacting with water at a given location on the beach based on the location of the shoreline; and
cause the vehicle to perform a predefined action based on the probability.

2. The vehicle of claim 1 further comprises a sensor configured to capture a first input associated with a vehicle's surrounding area.

3. The vehicle of claim 2, wherein the processor is configured to:
obtain the first input from the sensor; and
identify that the vehicle is entering the beach environment based on the first input.

4. The vehicle of claim 1, wherein the processor is configured to:
obtain a second input from an external server, wherein the second input is associated with a geolocation of the beach; and
identify that the vehicle is entering the beach environment based on the second input.

5. The vehicle of claim 1, wherein the processor is configured to:
obtain a third input from a second vehicle via vehicle-to-vehicle (V2V) communication; and
identify that the vehicle is entering the beach environment based on the third input.

6. The vehicle of claim 1, wherein the processor is configured to:
obtain a fourth input from an infrastructure unit via vehicle-to-everything (V2X) communication; and
identify that the vehicle is entering the beach environment based on the fourth input.

7. The vehicle of claim 1, wherein the processor is configured to:
obtain a fifth input from a user via a user interface; and
identify that the vehicle is entering the beach environment based on the fifth input.

8. The vehicle of claim 1, wherein the processor is configured to:
predict a tide location on the beach at the given time, when the beach mode is activated; and
predict the location of the shoreline on the beach at the given time based on the prediction of the tide location.

9. The vehicle of claim 8, wherein, to predict the tide location, the processor is configured to:
obtain a sixth input from an external server, wherein the sixth input comprises a tide schedule associated with the beach;
estimate a high tide water position and a low tide water position associated with the beach based on the sixth input; and
predict the tide location on the beach based on the estimation of the high tide water position and the low tide water position.

10. The vehicle of claim 8, wherein, to predict the tide location, the processor is configured to:
obtain a seventh input from a sensor, wherein the seventh input comprises inputs associated with a strandline on the beach; and
predict the tide location on the beach based on the seventh input.

11. The vehicle of claim 1, wherein the processor is configured to:
obtain an eighth input from an external server, wherein the eighth input comprises weather information associated with the beach; and
predict the location of the shoreline on the beach based on the eighth input.

12. The vehicle of claim 11, wherein, to perform the predefined action, the processor is configured to:
estimate a distance between the shoreline and the vehicle at the given location;
determine that the probability of the vehicle interacting with water is greater than a threshold value based on the distance; and
perform a remedial action responsive to determining that the probability of the vehicle interacting with water is greater than the threshold value.

13. The vehicle of claim 12, wherein, to perform the remedial action, the processor is configured to cause the vehicle to automatically relocate from a current location to another location on the beach.

14. The vehicle of claim 12, wherein, to perform the remedial action, the processor is configured to output a first notification requesting a user to move the vehicle from a current location to another location on the beach.

15. The vehicle of claim 14, wherein the processor is further configured to:
estimate a time duration for which the vehicle will not interact with water at the current location; and
output a second notification to the user when the time duration elapses.

16. The vehicle of claim 1, wherein the processor is further configured to set a maximum speed limit, responsive to activating the beach mode.

17. The vehicle of claim 16, wherein the processor is further configured to:
obtain a user request to enable a user to move the vehicle at a desired speed greater than the maximum speed limit; and
enable the vehicle to move at the desired speed responsive to obtaining the user request.

18. The vehicle of claim 2, wherein the processor is further configured to:
obtain inputs associated with a signage located on the beach from the sensor;
determine a geofenced boundary for the vehicle on the beach based on the inputs; and
cause the vehicle to operate within the geofenced boundary.

19. A method comprising:
identifying, by a processor, that a vehicle is entering a beach environment;
activating, by the processor, a beach mode responsive to identifying that the vehicle is entering the beach environment;
predicting, by the processor, a location of a shoreline on a beach at a given time, when the beach mode is activated;
determining, by the processor, a probability of the vehicle interacting with water at a given location on the beach based on the location of the shoreline; and
causing, by the processor, the vehicle to perform a predefined action based on the probability.

20. A non-transitory computer-readable storage medium having instructions stored thereupon which, when executed by a processor, cause the processor to:
identify that a vehicle is entering a beach environment;
activate a beach mode responsive to identifying that the vehicle is entering the beach environment;
predict a location of a shoreline on a beach at a given time, when the beach mode is activated;
determine a probability of the vehicle interacting with water at a given location on the beach based on the location of the shoreline; and
cause the vehicle to perform a predefined action based on the probability.
